(19) United States
(12) Patent Application Publication
(10) Pub. No.: US 2013/0073712 A1
(43) Pub. Date: Mar. 21, 2013

(54) OBJECT MANAGEMENT BY INFORMATION PROCESSING SYSTEM

(71) Applicants: Benoit Christophe, Nozay (FR); Wenyi Xu, Nozay (FR)

(72) Inventors: Benoit Christophe, Nozay (FR); Wenyi Xu, Nozay (FR)

(73) Assignee: Alcatel Lucent, Paris (FR)

(21) Appl. No.: 13/700,487

(22) PCT Filed: Mar. 9, 2011
(86) PCT No.: PCT/FR2011/050478

§ 371 Date: Nov. 28, 2012

(30) Foreign Application Priority Data
Jun. 1, 2010 (FR) 1054235

(51) Int. Cl. G06F 15/173

(52) U.S. Cl. 709/223

(57) ABSTRACT

A method for acting on an object by means of an interface with an information processing system, comprising a step of defining a logical representation of the object, a step of determining (by a user) and triggering a function of the object offered by the representation, and a step of communicating with the object for actually carrying out said function, which method is characterized in that the logical representation comprises at least one state graph in which the graph's states represent the states of the object, and the graph's transitions represent the object's functions, and in that the functions offered comprise the functions present on the outgoing transitions of the graph's current state.

The present invention relates to the interaction of an information processing system with physical objects.

There are proposals aimed at enabling a user of an information processing system to interact with physical objects that may appear in his or her environment. These physical objects may be personal objects such as home appliances (ovens, refrigerators, etc.), audiovisual equipment (televisions, hi-fi systems, etc.), or any other equipment (lights, heating, etc.). They may also be equipment from his or her professional environment, public equipment, etc.

The information processing systems may, for example, be the communication terminals which, via a web interface, make it possible to use those objects' functions. It may, for example, involve turning off a light remotely, or beginning the recording of a movie airing on a television channel using one's mobile telephone, etc.

State-of-the-art proposals aimed to varying extents at resolving this need do exist.

One proposal is the EPCGlobal solution from Audio-ID labs. It relies on the use of RFID identifiers (or “tags”) and proximity sensors to detect the presence of objects and to notify users of the locations of objects to which they are subscribed. This information is made accessible on a web interface.

However, this solution does not make it possible to control objects and access their functions.

Another proposal is the Touchatag platform based on the idea of associating actions, with RFID tags. By placing an RFID tag in front of the sensor, an action may automatically be triggered by the platform. This solution therefore affords a great deal of freedom in programming actions, but it does not manage the actual objects, and therefore has many limits. It cannot, for example, propose a list of possible actions to the user via a web interface; nor can it correctly manage which actions are possible or not depending on the object's state.

The Yaler initiative, described on the website www.yaler.org, consists of creating a gateway between objects connected to the web and the users' web interface. It enables the users to access the objects' functions, but suffers from the need to have this gateway, which therefore constitutes both a potential choke point and a vulnerability of the system.

Additionally, this solution considers the objects to be “services,” meaning a set of functions that are continually offered to the user.

The Web of Things initiative described on the website www.webofthings.com suffers from the same basic assumption that considers physical objects to be services accessible via the web.

The purpose of the invention consists of substantially improving the situation. According to the invention, objects are by nature different from services, in that their functions are not continually available. Instead, their availability depends on the state the object is in.

For example, the “pause” function of a CD or DVD player is only accessible if the object is playing media.

To do this, one object of the invention is a method for acting on an object by means of an interface with an information processing system, comprising
a step of defining a logical representation of the object,
a step of determining (by a user) and triggering a function of that object offered by the representation, and
a step of communicating with the object in order to actually carry out the function in question.

The inventive method is innovative in that the logical representation comprises at least one state graph in which the states of the graph represent the states of the object, and the transitions of the graph represent the object's functions, and in that these offered functions comprise the functions that are present in the outgoing transitions of the current state of the graph.

Thus, associating state graphs with the objects represented in the information processing system makes it possible to better take into account the very nature of the objects. It becomes possible to finely model their behavior and to ensure that the object is in the appropriate state before triggering a function.

This may be done, for example, by proposing to the user that their functions correspond to their current state.

It is also possible to offer the user additional functions. The method may then comprise, in the event that one of these additional functions is determined, a step of determining a path in the state graph(s) all the way to a state that has the additional function in question on an outgoing transition, and of automatically triggering functions that enable the following of that path.

The transitions of the state graph(s) may be associated with weights, these weights being used determine the path from among multiple possible paths.

The logical representation may comprise a plurality of state graphs, each one corresponding to a relationship between the user and the object, and comprising a step of determining the relationship in order to determine a graph from among the plurality of graphs.

The step of determining by a user may comprise the processing of that determination by at least one queue before the triggering of the function. A queue may be provided for each of the relationships, and priorities may be assigned to the relationships (and afterward, to the queues).

It is a further object of the invention to have a terminal and an information processing server intended for the deployment of that method and its implementations.

The invention, its benefits, and its characteristics will become more clearly apparent in the following description, with reference to the attached figures:

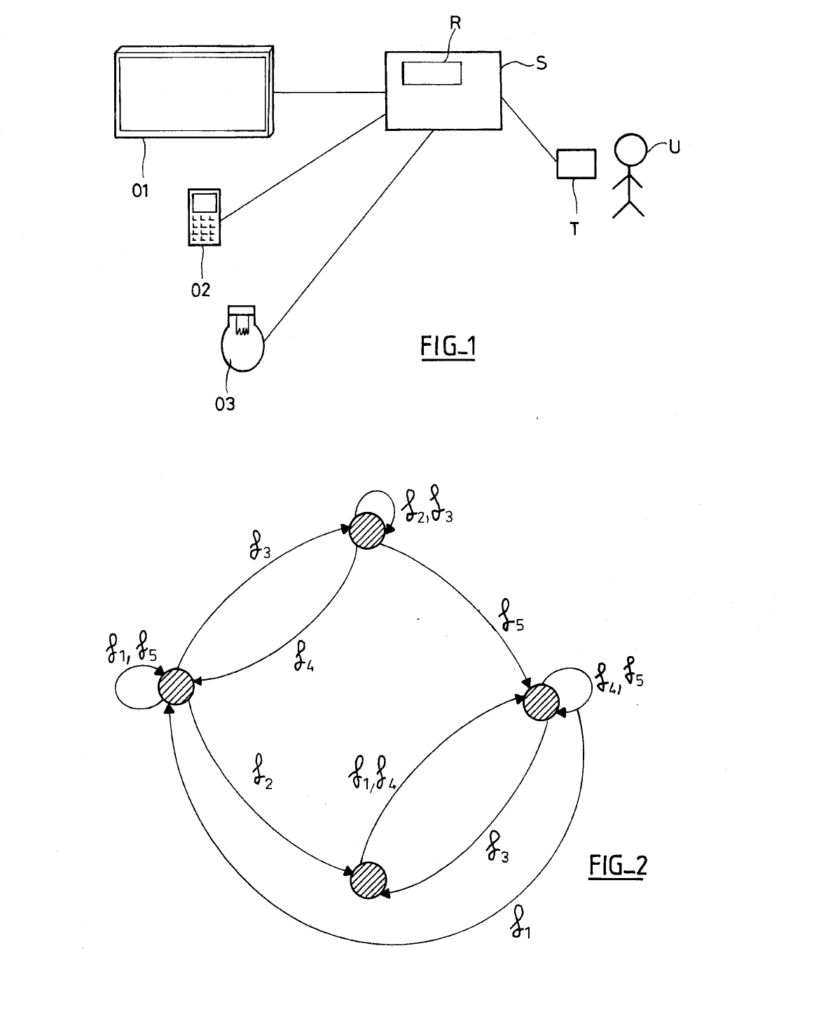

FIG. 1 depicts one possible implementation context of the invention.

FIG. 2 diagrams the representation of an object using a state graph.

In the example implementation illustrated by FIG. 1, the invention enables a user U to act on objects O1, O2, O3 by way of a communication terminal T comprising an interface with an information processing system. This information processing system may comprise different equipment and software devices.

It might be constituted only of the equipment embedded in the communicating terminal T.

It may, as in the example of FIG. 1, comprise a server S connected to the terminal T and to the objects O1, O2, O3.

The terminal T may comprise a web browser interface and communicate with the server S by normal web technology protocols like HTTP (HyperText Transfer Protocol) or by applications or Java applets, etc.

The use of a server S as in the example of FIG. 1 makes it possible to implement the invention in a centralized manner. As will be explained later on, is then possible to act on a single object from multiple terminals by optimally managing any conflicts that may arise.

The information processing system S comprises a set R of logical representations of objects. The inventive method therefore comprises an initial step of defining those logical representations.

According to the invention, the logical representation of an object comprises at least one state graph. Such a graph is depicted in FIG. 2.

States A, B, C, D represent distinct states of the modeled object. For example, for the telephone O2, it may be the states “on hold”, “talking on phone”, “recording a message”, “checking messages”. This example is purely an example, and the states may be determined based on the object's specific functioning.

The states are connected to one another by transitions (marked by oriented arrows in the figure). These transitions represent the object's functions.

For example, the transition from state B to state C shows that a single transition may represent multiple functions, in this case the functions f1 and f2.

This may, for example, be true for a telephone O2 in the state “checking messages”, which in the “on hold” state comes after the triggering of the “pickup” function and the “end checking” function.

From a given state, for example state B, two situations may be considered:
some functions put the object into another state: For example, this is true of function f1, which puts the object into state D;
some functions keep the object in the same state: For example, this is true of function f2.

In the example of a media player (CD, DVD, etc.), the “start playing” function puts the object from the “pause” or “standby” state into a “play” state, while the function “raise volume” leaves the object in the same state.

Additionally, the same function may be accessible from multiple states. This is true of function f2, which is accessible from states A, B and C. For example, for a media player, the function “raise volume” may be accessible from the “pause” state or from the “play” state.

Furthermore, it may be provided that the logical representation of an object comprises multiple state graphs. Each of these state graphs may correspond to a possible relationship between the user and the object.

These relationships may be, for example: administrator, owner, friend (or family, colleagues, etc. based on context) or anonymous. Other relationships, naturally, are possible. The remainder of the description is based on a group of 4 distinct relationships, but groups with different numbers of relationships are possible without departing from the scope of the invention.

These relationships or roles represent links that associate the object and the user, and may correspond to different rights for an object.

In some cases, the “owners” and “administrators” relationships may be conflated, but it can be beneficial in some situations to distinguish them. For example, in a professional environment, an administrator may have access to some functions that are inaccessible to its owner. Furthermore, the same computer may potentially be used by coworkers, but with access restricted to certain functions. Certain functions may additionally be accessible to any person (the “anonymous” relationship); this may, for example, be true of the “on” and “off” functions.

Each relationship therefore corresponds to a different subset of states and possible functions, and therefore a distinct state graph.

According to one implementation of the invention, the use of an object triggers the determination of the relationship between the user U and the object O1, O2, O3. Based on this relationship, the appropriate state graph is determined from among the set of graphs contained within the logical representation of that object.

It may additionally be provided to have at least one queue, particularly one queue per relationship and state graph. This (or these) queues make it possible to manage situations in which multiple users access the same object.

Each queue may correspond to a “first in, first out” (FIFO) model. However, other mechanisms may add nuance to this model. For example, it is possible to take geographic proximity into account and to give a higher priority to the one who is closest to the object rather than to another user who wishes to control it remotely.

Between the queues, priorities may also be specified. For example, the “owner” relationship may be higher-priority than the “friend” relationship, and the corresponding queue would receive preferential processing.

This mechanism makes it possible to manage the situation in which different functions are activated at the same time: the type of relationships (owner, friend, etc.), geographic proximity, or other parameters make it possible to give priority to one of the requests or the other.

However, it should be noted that some functions may be triggered at the same time without a conflict. Rather, some objects, in some states, can manage functions in parallel. For example, the television O1 can change channels while also changing the sound volume.

As stated above, only the subset of functions that corresponds to the current state is directly accessible to the users.

It may additionally be provided to offer the users additional functions above and beyond these ones.

For example, the web interface (or browser) may depict some or all of the object's functions.

In the event that the user determines one of those additional functions on the web interface, the inventive method then determines a path within the state graph all the way to a state that possesses the function in question on an outgoing transition.

In the example in FIG. 2, it is assumed that the current state is state A and that the chosen function is function f4. This function does not belong to any of the outgoing transitions of state A. This is therefore an “additional function” as defined above.

The information processing system may then determine one or more paths that lead from state A to a state that has f4 on an outgoing transition.

These paths are A→C and A→B, because C and B have f4 as a function on outgoing transition.

The system S may then automatically trigger the functions that make it possible to follow this path.

In other words, the system S determines which function is located on the path's transitions, and applies them one after another.

For example, it may apply function f3 to go to state C, or function f2 to go to state B.

The system S may choose one of those paths arbitrarily or based on a predetermined heuristic, or ask the user to choose.

The heuristic may be based on a notion of cost or constraint. For example, costs may be associated with the transitions, and the lowest-cost path will be chosen.

These costs may represent different criteria, such as energy consumption, an impact of the object's wear (for example, turning a device on and off may be associated with a high cost), the time to perform the function, etc.

Through this association of a state-based machine with objects, the invention additionally makes it possible to facilitate the management and cooperation of objects. An object monitoring tool may be proposed in order to enable such cooperation.

By cooperation, we mean an application or “mash-up” made up of multiple objects interacting with one another.

This module enables the management of simple dependencies between objects. By relying on the representation of each object, this module is capable of telling which data a given object expects and which objects involved in a composite application are capable of providing them to it.

This module is therefore capable of managing the placement of an object's use into a queue, and of causing the triggering of functions that belong to other objects, which are required for that object's execution. Finally, this module is capable of making the distinction between:
Making an object wait until all of the objects involved in its completion have been invoked, and
Making an object wait until a necessary but sufficient subgroup of objects has been invoked.

1) A method for acting on a physical object by means of an interface with an information processing system, comprising a step of defining a logical representation of said physical object, a step of determining by a user and triggering a function of said physical object offered by said representation, and a step of communicating with said physical object in order to actually perform said function, said method being characterized in that said logical representation comprises at least one state graph in which the states of said graph represent the states of said physical object, and the transitions of said graph represent functions of said physical object, and in that said offered functions comprise functions present on outgoing transitions of the current state of said graph.

2) A method according to claim 1, wherein additional functions are offered to said user, and comprising, in the event that said user determines an additional function, a step of determining a path within said at least one state graph all the way to a state that has said additional function on an outgoing transition, and of automatically triggering the functions that enable the following of that path.

3) A method according to claim 1, wherein the transitions of said at least one state graph are associated with weights, said weights being used to determine said path from among multiple possible paths.

4) A method according to claim 1, wherein said logical representation comprises a plurality of state graphs, each one comprising a relationship between said user and said object, and pricing a step of determining said relationship in order to determine a graph from among the plurality of graphs.

5) A method according to claim 1, wherein said relationship is comprised within a group comprising “administrator”, “owner”, “friend/family”, and “anonymous”.

6) A method according to claim 1, wherein said step of determining by a user comprises the processing of the determination by at least one queue before said triggering of said function.

7) A method according to claim 6, wherein a queue is provided for each of said relationships, and wherein priorities are assigned to said relationships.

8) A communication terminal for implementing a method according to claim 1.

9) An information processing server for implementing a method according to claim 1.
